(19) United States
(12) Patent Application Publication
(10) Pub. No.: US 2025/0074774 A1
(43) Pub. Date: Mar. 6, 2025

(54) METHOD FOR PRODUCING CARBON NANOTUBES

(71) Applicant: National Taiwan University, Taipei City (TW)

(72) Inventors: Chia-Wen WU, Taipei City (TW); Wei-Sheng LIAO, Taipei City (TW); Cheng-Kuan HSIEH, Taipei City (TW)

(21) Appl. No.: 18/758,491

(22) Filed: Jun. 28, 2024

Related U.S. Application Data
(60) Provisional application No. 63/515,173, filed on Jul. 24, 2023.

(51) Int. Cl. C01B 32/162; B01J 23/755; B01J 35/45; B01J 37/08

(52) U.S. Cl. CPC C01B 32/162; B01J 23/755; B01J 35/45; B01J 37/082; C01B 2202/02; C01B 2202/06; C01P 2002/01; C01P 2002/72; C01P 2002/82; C01P 2002/87; C01P 2002/88; C01P 2004/04

(57) ABSTRACT

A method for producing carbon nanotubes includes subjecting a plastic material and an acidic zeolite to a pyrolysis reaction so as to form a hydrocarbon compound having 1 to 6 carbon atoms. The acidic zeolite has a molar ratio of SiO₂ to Al₂O₃ ranging from 5.1:1 to 80:1. Another method for producing carbon nanotubes includes subjecting a hydrocarbon compound having 1 to 6 carbon atoms and a catalyst to a catalysis reaction so as to obtain the carbon nanotubes. The catalyst includes a support and a plurality of ferromagnetic nanoparticles supported on the support. The ferromagnetic nanoparticles have an average diameter ranging from 20 nm to 30 nm, and are derived from acetylacetonate of a ferromagnetic transition metal.

### CROSS-REFERENCE TO RELATED APPLICATION

This application claims the benefit of U.S. Provisional Patent Application No. 63/515,173, filed on Jul. 24, 2023, the entire disclosure of which is incorporated by reference herein.

### FIELD

The present disclosure relates to a method for producing carbon nanotubes, and more particularly to a method for producing carbon nanotubes from plastic waste material.

### BACKGROUND

Carbon nanotubes are one of the allotropes of carbon, and can exist as single-walled carbon nanotubes, which are cutouts from a two-dimensional graphene sheet rolled up to form hollow cylinders with a diameter of less than 30 nm, and multi-walled carbon nanotubes, which consist of nested single-walled carbon nanotubes in a nested, tube-in-tube structure with a diameter of greater than 100 nm. Carbon nanotubes exhibit remarkable properties, such as exceptional tensile strength and thermal conductivity, and an excellent electrical conductivity, and are expected to be valuable in many areas of technology, including electronics and semiconductors, optics, composite materials, batteries and capacitors, chemicals and polymers, medical applications, aerospace and defense, etc.

In comparison to multi-walled carbon nanotubes, single-walled carbon nanotubes have greater specific surface area, tensile strength and electrical conductivity, as well as higher purity (i.e., fewer defects), and thus is more competitive with respect to market price. At present, the carbon source for production of single-walled carbon nanotubes are mostly derived from pure hydrocarbon gases, such as methane, ethylene, and/or acetylene. In addition, previous studies have reported that hydrocarbon compounds having a relatively high number of carbon atoms are not conducive to the production of single-walled carbon nanotubes. The increased demand for single-walled carbon nanotubes has led many researches to search alternative carbon sources or develop improved methods for production of single-walled carbon nanotubes.

Therefore, there is an urgent need to develop a new strategy which allows single-walled carbon nanotubes to be produced in a relatively large amount using a simple manufacturing method with a low production cost.

### SUMMARY

Therefore, an object of the present disclosure is to provide a method for producing carbon nanotubes which can alleviate at least one of the drawbacks of the prior art.

According to an aspect of the present disclosure, the method includes subjecting a plastic material and an acidic zeolite to a pyrolysis reaction so as to form a hydrocarbon compound having 1 to 6 carbon atoms. The acidic zeolite has a molar ratio of SiO₂ to Al₂O₃ ranging from 5.1:1 to 80:1.

According to another aspect of the present disclosure, the method includes subjecting a hydrocarbon compound having 1 to 6 carbon atoms and a catalyst to a catalysis reaction so as to obtain the carbon nanotubes. The catalyst includes a support and a plurality of ferromagnetic nanoparticles supported on the support. The ferromagnetic nanoparticles have an average diameter ranging from 20 nm to 30 nm, and are derived from acetylacetonate of a ferromagnetic transition metal.

### BRIEF DESCRIPTION OF THE DRAWINGS

Other features and advantages of the present disclosure will become apparent in the following detailed description of the embodiment(s) with reference to the accompanying drawings. It is noted that various features may not be drawn to scale.

FIG. 1 is a flow diagram illustrating a method for producing carbon nanotubes according to the present disclosure.

FIG. 2 is a transmission electron microscopy (TEM) image showing a carbon layer being formed on the surface of a Fe nanoparticle obtained after a pyrolysis process for preparing a catalyst of Preparation Example 2 (PE2).

FIG. 3 shows an X-ray diffraction pattern of the catalysts of PE2 and Comparative Preparation Example 1 (CPE1).

FIG. 4 is a TEM image showing the carbon nanotubes (CNTs) of Example 9 (EX9).

FIG. 5 is a TEM image showing the CNTs of Comparative Example 1 (CE1).

FIG. 6 shows Raman spectra of the CNTs of EX9 and CE1.

FIG. 7 is a graph showing the yields of single-walled carbon nanotubes (SWCNTs), multi-walled carbon nanotubes (MWCNTs) and amorphous carbon determined from the CNTs of EX9 and CE1.

FIG. 8 are chromatograms showing the composition and the relative abundance of hydrocarbon compounds generated in the preparation of the CNTs of Example 2 (EX2) and EX9 at different retention times of gas chromatography-mass spectrometry (GC-MS) analysis.

FIG. 9 shows Raman spectra of the CNTs of Example 6 (EX6) to EX9.

FIG. 10 shows a differential thermogravimetric (DTG) curve of the CNTs of EX6.

FIG. 11 shows the DTG curve of the CNTs of Example 7 (EX7).

FIG. 12 shows the DTG curve of the CNTs of Example 8 (EX8).

FIG. 13 is a graph showing the yields of SWCNTs, MWCNTs and amorphous carbon determined from the CNTs of EX6 to EX9.

FIG. 14 shows the DTG curve of the CNTs of Example 1 (EX1).

FIG. 15 shows the DTG curve of the CNTs of Example 5 (EX5).

FIG. 16 graph showing the yields of SWCNTs, MWCNTs and amorphous carbon determined from the CNTs of EX1, EX5 and EX6.

FIG. 17 shows the DTG curve of the CNTs of Example 10 (EX10).

FIG. 18 shows the DTG curve of the CNTs of Example 11 (EX11).

FIG. 19 are chromatograms showing the composition and relative abundance of the hydrocarbon compounds generated in the preparation of the CNTs of EX1, EX10 and EX11 at different retention times of the GC-MS analysis.

FIG. 20 is a graph showing the yields of SWCNTs, MWCNTs and amorphous carbon determined from the CNTs of EX1, EX10 and EX11.

FIG. 21 are TEM images showing the CNTs of EX1, EX2 and Example 4 (EX4).

FIG. 22 is a graph showing the yields of SWCNTs, MWCNTs and amorphous carbon determined from the CNTs of EX1 to EX4.

FIG. 23 are chromatograms showing the composition and relative abundance of the hydrocarbon compounds generated in the preparation of the CNTs of Example 12 (EX12) to Example 14 (EX14), Comparative Example 2 (CE2) and Comparative Example 3 (CE3) at different retention times of the GC-MS analysis.

FIG. 24 is a graph showing the yields of SWCNTs, MWCNTs and amorphous carbon determined from the CNTs of EX12 to EX14, CE2 and CE3.

### DETAILED DESCRIPTION

Before the present disclosure is described in greater detail, it should be noted that if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

According to the present disclosure, a catalyst is used for producing carbon nanotubes from a plastic material, specifically, a plastic waste material.

According to the present disclosure, the catalyst includes a support and a plurality of ferromagnetic nanoparticles supported on the support.

In certain embodiments, the support includes a support material which includes silica, alumina, or a combination thereof. In certain embodiments, the support material is silica.

In certain embodiments, the ferromagnetic nanoparticles includes a ferromagnetic transition metal which includes iron, cobalt, nickel, or combinations thereof. In certain embodiments, the ferromagnetic transition metal is iron.

In certain embodiments, the ferromagnetic nanoparticles have an average diameter ranging from 20 nm to 30 nm.

In certain embodiments, the ferromagnetic nanoparticles are derived from acetylacetonate of a ferromagnetic transition metal.

In certain embodiments, the catalyst is synthesized by subjecting a mixture containing the support material and acetylacetonate of the ferromagnetic transition metal to a pyrolysis process to form a reaction intermediate which includes the support, the ferromagnetic nanoparticles supported on the support, and a carbon layer coated on the ferromagnetic nanoparticles; and subjecting the reaction intermediate to a calcination process and a reduction process so as to obtain the catalyst.

In certain embodiments, before the pyrolysis process, the mixture containing the support material and acetylacetonate of the ferromagnetic transition metal is dried at a temperature ranging from 105° C. to 110° C. In certain embodiments, before the pyrolysis process, the mixture containing the support material and acetylacetonate of the ferromagnetic transition metal is dried for a time period ranging from 12 hours to 24 hours. In certain embodiments, before the pyrolysis process, the mixture containing the support material and acetylacetonate of the ferromagnetic transition metal is dried at a temperature of 105° C. for a time period of 12 hours.

In certain embodiments, the pyrolysis process is conducted under an inert atmosphere. In some embodiments, the inert atmosphere includes nitrogen gas, argon gas, or a combination thereof.

In certain embodiments, the pyrolysis process is conducted at a temperature ranging from 450° C. to 500° C. In certain embodiments, the pyrolysis process is conducted for a time period ranging from 15 minutes to 30 minutes. In certain embodiments, the pyrolysis process is conducted at a temperature of 450° C. for a time period of 30 minutes.

According to the present disclosure, after the pyrolysis process, the carbon layer formed on the ferromagnetic nanoparticles can be removed by the calcination process. In certain embodiments, the calcination process is conducted at a temperature ranging from 750° C. to 900° C. In certain embodiments, the calcination process is conducted for a time period ranging from 3 hours to 6 hours. In certain embodiments, the calcination process is conducted at a temperature of 800° C. for a time period of 3 hours.

In certain embodiments, the reduction process is conducted under an atmosphere containing hydrogen so as to reduce ferric oxide (Fe₂O₃), which may be formed on the surfaces of the Fe nanoparticles, to iron (Fe), thereby obtaining the catalyst. In certain embodiments, the reduction process is conducted at a temperature ranging from 600° C. to 800° C. In certain embodiments, the reduction process is conducted for a time period ranging from 1 hour to 3 hours. In certain embodiments, the reduction process is conducted at a temperature of 600° C. for a time period of 3 hours.

In certain embodiments, the ferromagnetic nanoparticles are present in an amount ranging from 5 wt % to 30 wt % based on 100 wt % of the catalyst. In certain embodiments, the ferromagnetic nanoparticles are present in an amount of 5 wt % based on 100 wt % of the catalyst. In certain embodiments, the ferromagnetic nanoparticles are present in an amount of 10 wt % based on 100 wt % of the catalyst. In certain embodiments, the ferromagnetic nanoparticles are present in an amount of 20 wt % based on 100 wt % of the catalyst. In certain embodiments, the ferromagnetic nanoparticles are present in an amount of 30 wt % based on 100 wt % of the catalyst.

Referring to FIG. 1, a method for producing carbon nanotubes according to the present disclosure includes the steps of: S1) subjecting a plastic material (for example, but not limited to, a plastic waste material) and an acidic zeolite to a pyrolysis reaction so as to form a hydrocarbon compound having 1 to 6 carbon atoms; and S2) subjecting the hydrocarbon compound and the aforesaid catalyst to a catalysis reaction so as to obtain the carbon nanotubes.

In certain embodiments, the acidic zeolite has a molar ratio of SiO₂ to Al₂O₃ ranging from 5.1:1 to 80:1. In certain embodiments, the acidic zeolite has a molar ratio of SiO₂ to Al₂O₃ of 30:1. In certain embodiments, the acidic zeolite has a molar ratio of SiO₂ to Al₂O₃ of 60:1. In certain embodiments, the acidic zeolite has a molar ratio of SiO₂ to Al₂O₃ of 86:1.

In certain embodiments, the plastic material includes a polyolefin. In certain embodiments, the polyolefin includes polyethylene, polypropylene, polybutylene, polypentylene, or combinations thereof. In certain embodiments, the polyethylene includes very low-density polyethylene (vLDPE), low-density polyethylene (LDPE), high-density polyethylene (HDPE), or combinations thereof. In certain embodiments, the plastic material is vLDPE. In certain embodiments, the plastic material is LDPE. In certain embodiments, the plastic material is HDPE.

In certain embodiments, the hydrocarbon compound includes ethylene, propene, propane, cyclopropane, methylcyclopropane, 2-methyl-2-butene, hexane, or combinations thereof. In certain embodiments, the hydrocarbon compound includes ethylene, propene, propane, cyclopropane, methylcyclopropane, or combinations thereof.

In certain embodiments, a weight ratio of the acidic zeolite to the plastic material ranges from 0.25:1 to 2.5:1. In certain embodiments, the weight ratio of the acidic zeolite to the plastic material is 0.25:1. In certain embodiments, the weight ratio of the acidic zeolite to the plastic material is 0.5:1. In certain embodiments, the weight ratio of the acidic zeolite to the plastic material is 2.5:1.

In certain embodiments, a weight ratio of the catalyst to the plastic material ranges from 0.3:1 to 2:1. In certain embodiments, the weight ratio of the catalyst to the plastic material is 1:2.

According to the present disclosure, the pyrolysis reaction for forming the hydrocarbon compound having 1 to 6 carbon atoms is conducted in a first reactor, and the catalysis reaction for forming the hydrocarbon compound into the carbon nanotubes is conducted in a second reactor disposed downstream of the first reactor.

In certain embodiments, the pyrolysis reaction is conducted under an inert atmosphere. In some embodiments, the inert atmosphere includes nitrogen gas, argon gas, or a combination thereof. In certain embodiments, the pyrolysis reaction is conducted at a temperature ranging from 450° C. to 600° C. In certain embodiments, the pyrolysis reaction is conducted for a time period ranging from 30 minutes to 120 minutes. In certain embodiments, the pyrolysis reaction is conducted at a temperature of 500° C. for a time period of 30 minutes.

In certain embodiments, the first reactor was continuously fed with nitrogen gas with a flow rate of ranging from 50 mL per minute to 200 mL per minute. In certain embodiments, the first reactor was continuously fed with nitrogen gas with a flow rate of 50 mL per minute. In certain embodiments, the first reactor was continuously fed with nitrogen gas with a flow rate of 100 mL per minute. In certain embodiments, the first reactor was continuously fed with nitrogen gas with a flow rate of 200 mL per minute.

In certain embodiments, a retention time period of the hydrocarbon compound in the first reactor ranges from 0.5 seconds to 20.0 seconds. In certain embodiments, the retention time period of the hydrocarbon compound in the first reactor is 1.27 seconds. In certain embodiments, the retention time period of the hydrocarbon compound in the first reactor is 2.54 seconds. In certain embodiments, the retention time period of the hydrocarbon compound in the first reactor is 5.08 seconds.

In certain embodiments, the hydrocarbon compound generated from the pyrolysis reaction was carried from the first reactor into the second reactor by the nitrogen gas under a flow rate ranging from 50 mL per minute to 200 mL per minute. In certain embodiments, the hydrocarbon compound generated from the pyrolysis reaction was carried from the first reactor into the second reactor by the nitrogen gas under a flow rate of 50 mL per minute. In certain embodiments, the hydrocarbon compound generated from the pyrolysis reaction was carried from the first reactor into the second reactor by the nitrogen gas under a flow rate of 100 mL per minute. In certain embodiments, the hydrocarbon compound generated from the pyrolysis reaction was carried from the first reactor into the second reactor by the nitrogen gas under a flow rate of 200 mL per minute.

In certain embodiments, the catalysis reaction is conducted under an inert atmosphere. In some embodiments, the inert atmosphere includes nitrogen gas, argon gas, or a combination thereof. In certain embodiments, the catalysis reaction is conducted at a temperature ranging from 700° C. to 1000° C. In certain embodiments, the catalysis reaction is conducted for a time period ranging from 30 minutes to 120 minutes. In certain embodiments, the catalysis reaction is conducted at a temperature of 800° C. for a time period of 30 minutes. In certain embodiments, the catalysis reaction is conducted at a temperature of 850° C. for a time period of 30 minutes.

In certain embodiments, the carbon nanotubes produced by the method of the present disclosure have a diameter ranging from 14 nm to 120 nm. In certain embodiments, the carbon nanotubes have a diameter ranging from 30 nm to 40 nm. In certain embodiments, the carbon nanotubes have a diameter ranging from 14 to 24 nm. In certain embodiments, the carbon nanotubes have a diameter ranging from 100 nm to 120 nm.

The present disclosure will be described by way of the following examples. However, it should be understood that the following examples are intended solely for the purpose of illustration and should not be construed as limiting the present disclosure in practice.

### PREPARATION EXAMPLES: PREPARATION OF CATALYST

### Preparation Example 1 (PE1)

First, 0.63 g of iron(III) acetylacetonate [Fe(acac)₃](Manufacturer: Alfa Aesar; CAS No.: 14024-18-1) was dissolved in 30 mL of water, and then mixed with 0.9 g of silicon dioxide (SiO₂) (Manufacturer: Fisher Chemical; CAS No.: 7631-86-9) under stirring to form a mixture. Next, the mixture was dried in an oven (Manufacturer: Prema; Model No.: RHDM-452) at a temperature of 105° C. overnight, followed by a pyrolysis process conducted in a tubular furnace (Manufacturer: Thermo Scientific; Model No.: TF55035A) at 450° C. for 30 minutes under an inert atmosphere containing nitrogen to form a reaction intermediate. The reaction intermediate was subjected to imaging and photography using a transmission electron microscope (TEM) (Manufacturer: JEOL; Model no.: JEM-2100F), so as to determine that the reaction intermediate includes SiO₂, Fe nanoparticles supported on the SiO₂, and a carbon layer coated on each of the Fe nanoparticles. Thereafter, the reaction intermediate was subjected to a calcination process conducted in a Thermolyne™ industrial benchtop muffle furnace at 800° C. for 3 hours under air to remove the carbon layer, and then to a reduction process conducted in the aforesaid tubular furnace at 600° C. for 30 minutes under an inert atmosphere containing hydrogen so as to reduce ferric oxide (Fe₂O₃), which may be formed on the surfaces of the Fe nanoparticles, thereby obtaining a catalyst of PE1 which includes SiO₂ serving as a support and Fe nanoparticles supported on SiO₂. Subsequently, an amount of Fe in the catalyst was determined by inductively coupled plasma optical emission spectroscopy, and was calculated to be 5 wt % based on 100 wt % of Fe nanoparticles supported on SiO₂.

### Preparation Examples 2 to 4 (PE2 to PE4)

The procedures and conditions for preparing the catalysts of PE2 to PE4 were substantially similar to those of PE1, except that for PE2 to PE4, 0.63 g, 1.26 g and 1.89 g of the Fe(acac)₃ were used, respectively, such that in the thus obtained catalysts of PE2 to PE4, Fe were present in amounts of 10 wt %, 20 wt % and 30 wt %, respectively, based on 100 wt % of the catalyst of PE2 to PE4, respectively.

### Comparative Preparation Example 1 (CPE1)

The procedures and conditions for preparing the catalyst of CPE1 were substantially similar to those of PE1, except that: (i) instead of Fe(acac)₃, 0.72 g of iron (III) nitrate nonhydrate [Fe(NO₃)₃·9H₂O] was used, and (ii) the pyrolysis process was not conducted, such that in the thus obtained catalyst of CPE1, Fe was present in an amount of 10 wt % based on 100 wt % of the catalyst of CPE1.

### EXAMPLES: PREPARATION OF CARBON NANOTUBES

### Example 1 (EX1)

The carbon nanotubes were prepared in a fixed bed reactor (Manufacturer: Jang Kwang Industrial Instrument Co., Ltd.; Model no.: CMF-5X1.7) including a first reactor and a second reactor disposed downstream of the first reactor which were connected to a nitrogen gas supply source.

First, the first reactor and the second reactor were respectively preheated to temperatures of 500° C. and 800° C. under a ramping rate of 30° C. per minute, followed by holding for 30 minutes. Next, 0.2 g of very low-density polyethylene (vLDPE), i.e., a polymer of plastic waste material (Source: Formosa Chemicals & Fibre Corporation) and 0.05 g of CBV 720, i.e., an acidic zeolite having a molar ratio of SiO₂ to Al₂O₃ of 30:1, (Source: Prof. Dun-Yen Kang's laboratory, Department of Chemical Engineering, National Taiwan University) were mixed and then subjected to a pyrolysis reaction conducted in the first reactor at a temperature of 500° C. for 30 minutes. During the pyrolysis reaction, the first reactor was continuously fed with nitrogen gas from the nitrogen gas supply source with a flow rate of 100 mL per minute, so as to allow the pyrolysis reaction to be conducted under an inert atmosphere. The hydrocarbon compounds generated from the pyrolysis reaction were carried by the nitrogen gas, under a flow rate of 100 mL per minute, from the first reactor into the second reactor with a retention time of 2.54 seconds in the first reactor. Thereafter, the hydrocarbon compounds were mixed with 0.1 g of the catalyst of PE1, i.e., Fe nanoparticles supported on SiO₂, in which Fe was present in an amount of 5 wt % based on 100 wt % of the catalyst, and then subjected to a catalysis reaction conducted in the second reactor at a temperature of 800° C. for 30 minutes, so as to obtain carbon nanotubes of EX1.

### Examples 2 to 4 (EX2 to EX4)

The procedures and conditions for preparing the carbon nanotubes of EX2 to EX4 were similar to those of EX1, except that for EX2 to EX4, the catalysts used were those of PE2 to PE4, respectively.

### Examples 5 and 6 (Ex5 and Ex6)

The procedures and conditions for preparing the carbon nanotubes of EX5 and EX6 were similar to those of EX2, except that for EX5 and EX6, the amounts of CVB 720 were 0.1 g and 0.5 g, respectively.

### Example 7 (EX7)

The procedures and conditions for preparing the carbon nanotubes of EX7 were similar to those of EX2, except that for EX7, the acidic zeolite used was CBV 760 (molar ratio of SiO₂ to Al₂O₃ of 60:1) in an amount of 0.5 g.

### Example 8 (EX8)

The procedures and conditions for preparing the carbon nanotubes of EX8 were similar to those of EX2, except that for EX8, the acidic zeolite used was HZSM-5 (molar ratio of SiO₂ to Al₂O₃ of 86:1) in an amount of 0.5 g.

### Example 9 (EX9)

The procedures and conditions for preparing the carbon nanotubes of EX9 were similar to those of EX2, except that for EX9, the acidic zeolite was omitted.

### Examples 10 and 11 (EX10 and EX11)

The procedures and conditions for preparing the carbon nanotubes of EX10 and EX11 were similar to those of EX1, except that for EX10 and EX11, the first reactor was continuously fed with nitrogen gas under flow rates of 50 mL per minute and 200 mL per minute, respectively, and the hydrocarbon compounds generated from the pyrolysis reaction were carried by the nitrogen gas from the first reactor into the second reactor under flow rate of 50 mL per minute with retention time of 5.08 seconds in the first reactor, and flow rate of 200 mL per minute with retention time of 1.27 seconds in the first reactor, respectively.

### Examples 12 to 14 (EX12 to EX14)

The procedures and conditions for preparing the carbon nanotubes of EX12 to EX14 were similar to those of EX2, except that for EX12 to EX14, the polymers of plastic waste materials were low-density polyethylene (LDPE) (Source: wash bottles), high-density polyethylene (HDPE) (Source: wash bottles) and polypropylene (PP) (Source: beverage cups), respectively. The LDPE, HDPE and PP were collected from wash bottles and beverage cups, and were washed, dried and cut into flasks having a dimension of 3 mm×3 mm.

### Comparative Example 1 (CE1)

The procedures and conditions for preparing the carbon nanotubes of CE1 were similar to those of EX2, except that for CE1, the catalyst used was that of PCE1.

### Comparative Examples 2 and 3 (CE2 and CE3)

The procedures and conditions for preparing the carbon nanotubes of CE2 and CE3 were similar to those of EX1, except that for CE2 and CE3, the polymers of plastic waste materials were polystyrene (PS) (Source: cell culture plates) and polyethylene terephthalate (PET) (Source: PET bottles), respectively. The PS and PET were collected from cell culture plates and PET bottles, and were washed, dried and cut into flasks having a dimension of 3 mm×3 mm.

### Property Evaluation

### 1. Effect of Carbon Layer Formed on the Fe Nanoparticles on the Size of the Same

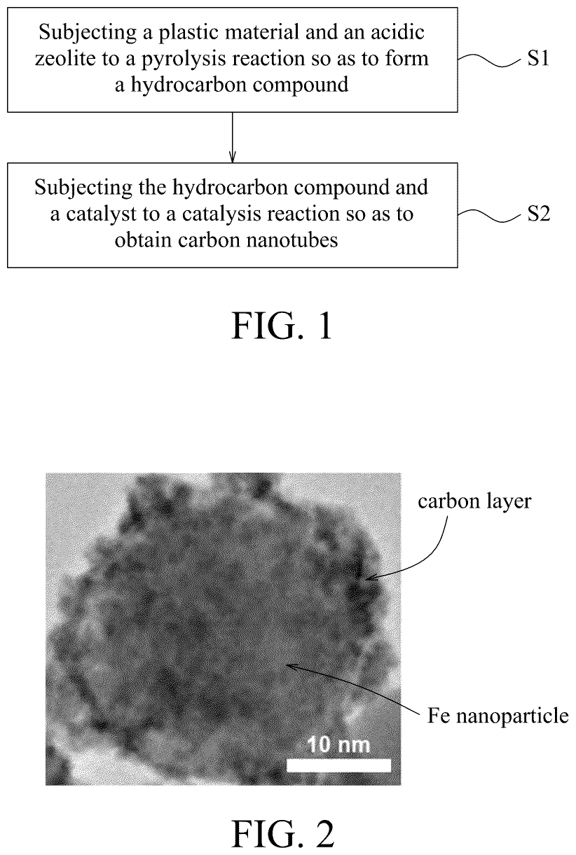

In order to visualize the carbon layer formed on the surface of the Fe nanoparticles, the reaction intermediate obtained after the pyrolysis process in the preparation of the catalyst of PE2 was subjected to imaging and photography using a transmission electron microscope (TEM) (Manufacturer: JEOL; Model no.: JEM-2100F). The result is shown in FIG. 2.

FIG. 2 is a TEM image showing the carbon layer (represented by black color) being formed on the surface of the Fe nanoparticle (represented by grey color) after the pyrolysis process during the preparation of the catalyst of PE2. It should be noted that, carbon layers would not be formed on the surface of the Fe nanoparticles after the pyrolysis process during the preparation of the catalyst of CPE1 because iron (III) nitrate nonahydrate was used as a precursor for preparing the catalyst of CPE1, and the pyrolysis process was not conducted (result not shown).

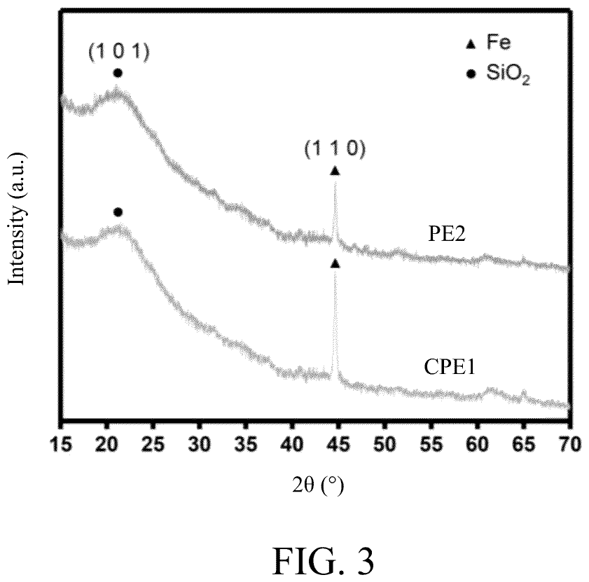

Next, in order to determine the average size of the Fe nanoparticles of the catalysts of PE2 and CPE1, the catalyst of a respective one of PE2 and CPE1 was subjected to X-ray diffraction (XRD) analysis using X-ray diffractometer (Manufacturer: Rigaku; Model no.: SmartLab SE). The XRD pattern of the catalysts of a respective one of PE2 and CPE1 was shown in FIG. 3, and the related parameters extracted from such XRD pattern were used to determine the average size of the Fe nanoparticles of the catalyst of a respective one of PE2 and CPE1 using the following Scherrer Equation (I):

$$D = K λ \div ( β \cdot cos θ ) \qquad ( I )$$

where,
D represents mean a nanocrystallite size,
K represents a dimensionless shape factor with a value of 0.89,
λ represents an X-ray wavelength,
β represents a full width at half maximum (FWHM), and
θ represents a Bragg angle.

The result is shown in Table 1 below.

TABLE 1

| | PE2 | CPE1 |
|---|---|---|
| Average size of Fe nanoparticles (nm) | 22.4 | 34.6 |

As shown in Table 1, the average size of the Fe nanoparticles supported on the SiO₂ of the catalyst of PE2 was smaller than that of the catalyst of CPE1, indicating that during the preparation of the catalyst of PE2, the carbon layer formed on the surface of the Fe nanoparticles after the pyrolysis process served as a protection layer that was capable of inhibiting severe aggregation of metal Fe, whereas during the preparation of the catalyst of CPE1, severe aggregation of metal Fe probably occurred due to the absence of carbon layer on the surface of the Fe nanoparticles.

### 2. Effect of Size of Fe Nanoparticles of Catalyst on the Size of Carbon Nanotubes (CNTs)

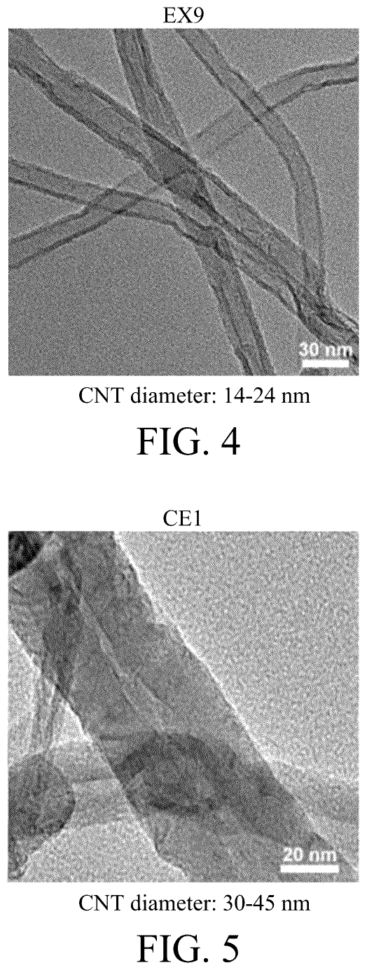

In order to determine whether the size of the Fe nanoparticles of the catalyst used in the catalysis reaction would affect the size of the CNTs thus obtained, the CNTs of a respective one of EX9 and CE1 were subjected to imaging and photography using the TEM as mentioned in Item 1 above, so as to determine the diameter of the CNTs. The results are shown in FIGS. 4 and 5.

FIGS. 4 and 5 are TEM images showing the CNTs of EX9 and CE1, respectively. As shown in FIG. 4, the CNTs of EX9 had a diameter ranging from 14 nm to 24 nm, and as shown in FIG. 5, the CNTs of CE1 had a diameter ranging from 30 nm to 45 nm. These results demonstrated that, the severe aggregation of metal Fe occurring in the preparation of the catalyst of CPE1 resulted in the CNTs of CE1 prepared using such catalyst having a relatively large size, whereas the absence of severe aggregation of metal Fe after the pyrolysis process in the preparation of the catalyst of PE2 leads to the CNTs of EX9 prepared using such catalyst having a relatively small size, and also suggested that the size of the Fe nanoparticles of the catalyst is positively correlated with the size of the CNTs.

### 3. Effect of Size of Fe Nanoparticles of Catalyst on the Yields of Single-Walled Carbon Nanotubes (SWCNTs), Multi-Walled Carbon Nanotubes (MWCNTs) and Amorphous Carbon

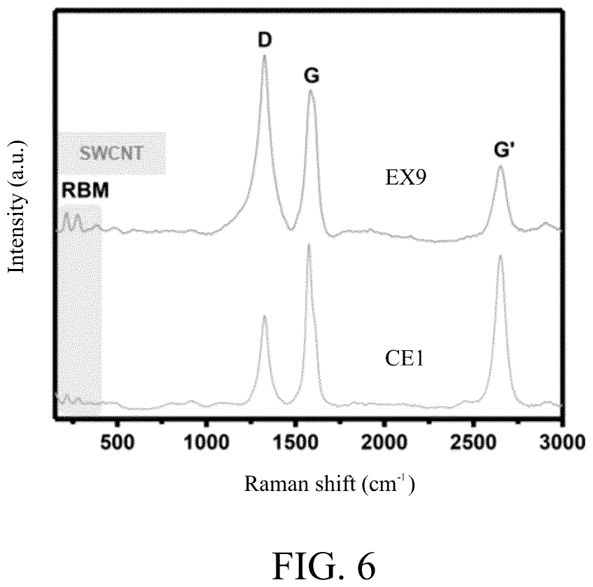

The CNTs of a respective one of EX9 and CE1 were subjected to Raman spectroscopy using a Raman spectrometer (Manufacturer: Renishaw; Model no.: inVia™) that was equipped with 10% laser power with a wavelength of 633 nm so as to determine the composition of the same. The result is shown in FIG. 6.

FIG. 6 shows Raman spectra of the CNTs of a respective one of EX9 and CE1. As shown in FIG. 6, the presence of SWCNTs in a respective one of EX9 and CE1 was indicated by the shaded area, i.e., “RBM” (radial breathing modes) at Raman shift ranging from 100 cm⁻¹ to 300 cm⁻¹, where all the carbon atoms of the SWCNTs undergo an equal radial displacement. It should be noted that the frequency of RBM is inversely proportional to the diameter of SWCNTs. In addition, the peak at approximately 1580 cm⁻¹, which is commonly referred as the “G-band”, indicates the presence of different types of graphite samples, such as pyrolytic graphite and charcoal, while the peak at approximately 1355 cm⁻¹, which is commonly referred as the “D-band”, indicates the presence of amorphous carbon or defects in the graphene plates or from the edges of the graphite crystal.

Next, the CNTs of a respective one of EX9 and CE1 were subjected to thermogravimetric analysis (TGA) using a thermogravimetric analyzer (Manufacturer: TA Instruments; Model no.: SDT 650), so as to obtain a differential thermogravimetric (DTG) curve derived from a TGA curve, followed by determining the weights of the SWCNTs, MWCNTs and amorphous carbon based on the integrated areas under the DTG curve at different temperature ranges, i.e., 300° C. to 450° C., 450° C. to 600° C. and 500° C. to 700° C. Thereafter, the yields of SWCNTs, MWCNTs and amorphous carbon of a respective one of EX9 and CE1 were calculated using the following Equation (II):

$$Y = ( A \div B ) \times 100 \% \qquad ( II )$$

where,
Y represents percentage of yield of SWCNTs, MWCNTs or amorphous carbon,
A represents weight of SWCNT, MWCNT or amorphous carbon, and
B represents weight of the catalyst.

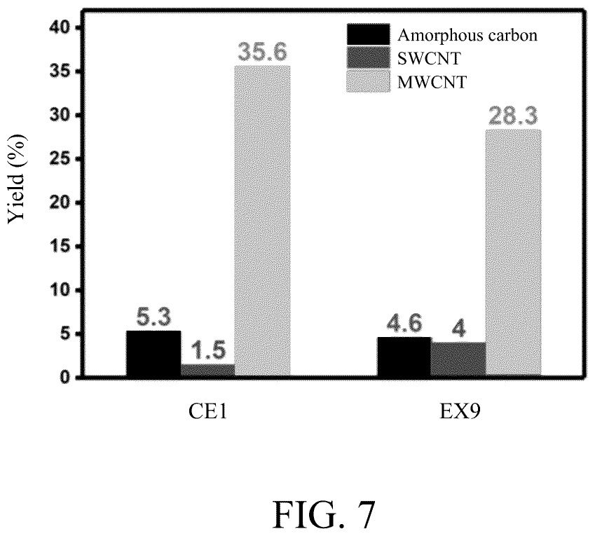

The result is shown in FIG. 7.

FIG. 7 is a graph showing the yields of SWCNTs, MWCNTs and amorphous carbon determined from the CNTs of a respective one of EX9 and CE1. As shown in FIG. 7, the yield of SWCNTs in the CNTs of EX9 was higher compared with that of CE1 while the yields of MWCNTs and amorphous carbon in the CNTs of EX9 were lower compared with those of CE1, indicating that a smaller size of Fe nanoparticles of catalyst, which resulted in the CNTs thus obtained having a smaller diameter, would also resulted in a greater yield of SWCNTs and reduced yields of MWCNTs and amorphous carbon.

### 4. Effect of Addition of Zeolite on the Composition of Hydrocarbon Compounds

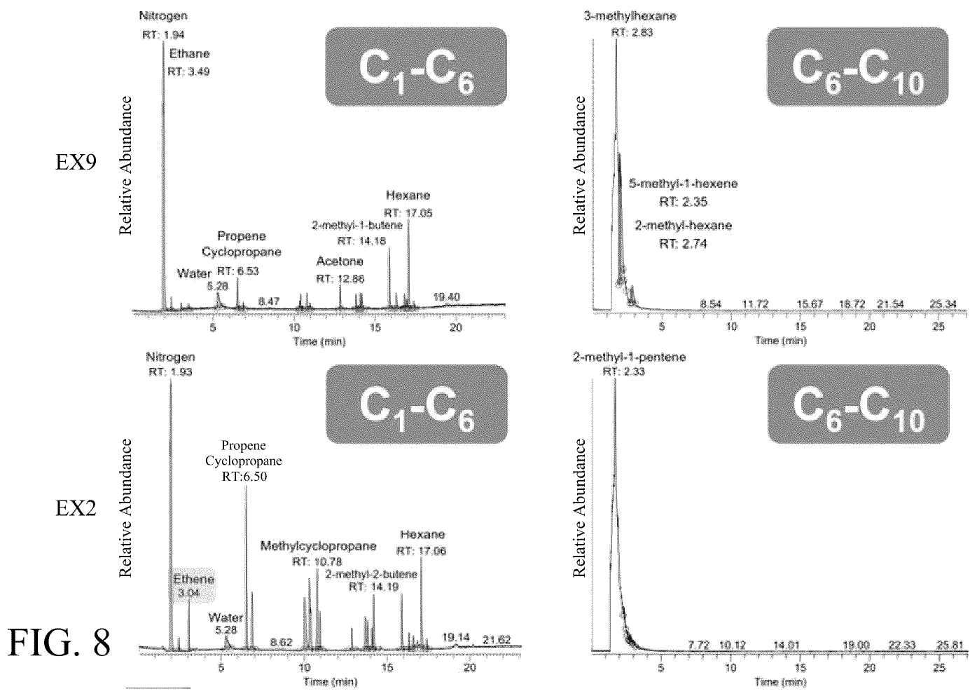

It should be noted that use of zeolite in the pyrolysis reaction of a plastic material facilitates production of hydrocarbon compounds having 1 to 6 carbon atoms in a relatively large amount. In this experiment, the hydrocarbon compounds generated after the pyrolysis reaction in the preparation of the CNTs of a respective one of EX2 and EX9 were subjected to gas chromatography-mass spectrometry (GC-MS) analysis using Agilent 7890B Triple Quadrupole GC-MS System (Manufacturer: Agilent Technologies) so as to determine the composition and relative abundance of such hydrocarbon compounds. The result is shown in FIG. 8.

FIG. 8 are chromatograms showing the composition and the relative abundance of the hydrocarbon compounds generated in the preparation of the CNTs of a respective one of EX2 and EX9 at different retention times of the GC-MS analysis. As shown in FIG. 8, the relative abundance of hydrocarbon compounds having 1 to 6 carbon atoms, e.g., ethylene, propene, propane, cyclopropane, methylcyclopropane, 2-methyl-2-butene, and hexane, were greater in EX2 compared with that in EX9, indicating that the presence of an acidic zeolite, such as CBV 720, during the pyrolysis reaction facilitates formation of hydrocarbon compounds with small number of carbon atoms.

### 5. Effect of Acidity of Zeolite on the Yield of SWCNTs

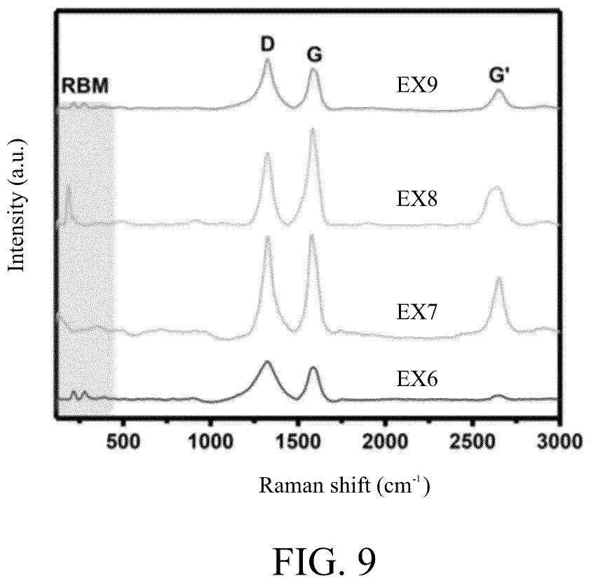

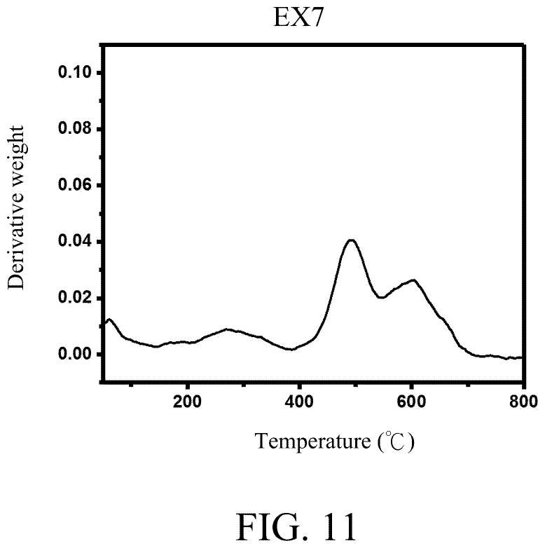

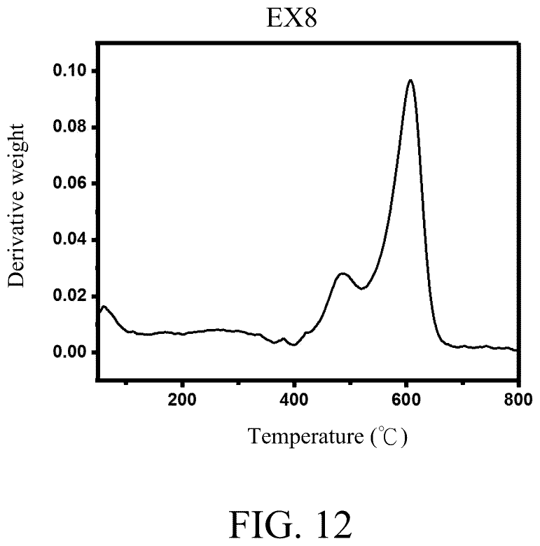

It has been reported that hydrocarbon compounds having small number of carbon atoms, formation of which are facilitated by zeolite, are conducive to the production of SWCNTs. It should be noted that the acidity of a zeolite is defined by the molar ratio of SiO₂ to Al₂O₃, i.e., acidity increases with decreasing molar ratio of SiO₂ to Al₂O₃. In this experiment, the CNTs of EX6 to EX8, which were respectively prepared using acidic zeolites with molar ratios of SiO₂ to Al₂O₃ being 1:30, 1:60 and 1:86, and the CNTs of EX9 (serving as control), were subjected to Raman spectroscopy and TGA as described in Item 3 above, followed by determination of the yields of SWCNTs, MWCNTs and amorphous carbon using the Equation (II) as described in Item 3 above. The results are shown in FIGS. 9 to 13.

FIG. 9 shows Raman spectra of the CNTs of a respective one of EX6 to EX9. As shown in FIG. 9, the presence of SWCNTs in a respective one of EX6 to EX9 was indicated by the shaded area, i.e., “RBM” at Raman shift ranging from 100 cm⁻¹ to 300 cm⁻¹.

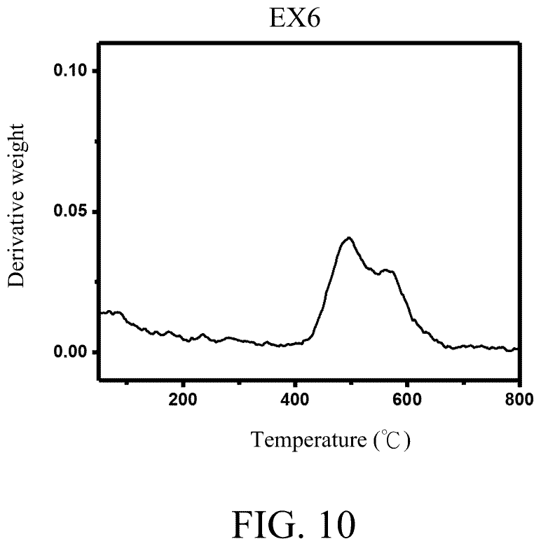

FIGS. 10 to 12 respectively show the DTG curves of the CNTs of EX6, EX7 and EX8 derived from the TGA curves of the same.

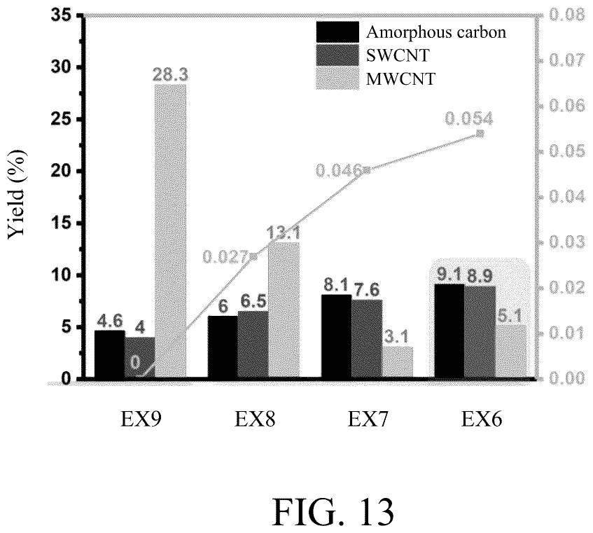

FIG. 13 is a graph showing the yields of SWCNTs, MWCNTs and amorphous carbon determined from the CNTs of a respective one of EX6 to EX9. As shown in FIG. 13, the yield of SWCNTs in a respective one of EX6 to EX8 was higher compared to that in EX9 while the yields of MWCNTs and amorphous carbon in a respective one of EX6 to EX8 were lower compared to those in EX9, indicating that the presence of zeolite, which resulted in a relatively high amount of hydrocarbon compounds having small number of carbon atoms being produced after the pyrolysis reaction, would lead to an improved yield of SWCNTs. In addition, the yield of SWCNTs in a respective one of EX6 and EX7 was higher compared with that in EX8, while the yield of MCWNTs in a respective one of EX6 and EX7 was lower compared with that in EX8 of SWCNT. Moreover, the yield of SWCNTs in EX6 was higher compared with that of EX7. These results indicate that use of a zeolite with a relatively high acidity (i.e., CVB 720 having a relatively low molar ratio of SiO₂ to Al₂O₃) contributes to the increase in the yield of SWCNTs.

### 6. Effect of Weight Ratio of an Acidic Zeolite to Plastic Material on the Yield of SWCNTs

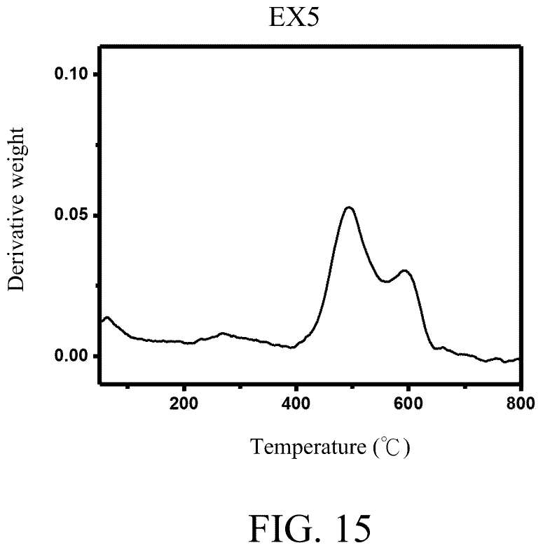

Since the results shown in FIGS. 9 to 13 indicate that use of CVB 720 in the pyrolysis reaction resulted in a higher yield of SWCNTs compared to the yields of SWCNTs obtained with use of CVB 760 and HZSM-5, in this experiment, the CNTs of EX1, EX5 and EX6, which were respectively prepared using plastic material (i.e., LDPE) and acidic zeolite (i.e., CBV 720) with weight ratios thereof being 0.25:1, 0.5:1 and 2.5:1, were subjected to TGA as described in Item 3 above, followed by determination of the yields of SWCNTs, MWCNTs and amorphous carbon using the Equation (II) as described in Item 3 above. The results are shown in FIGS. 10 and 14 to 16.

FIGS. 10, 14 and 15 respectively show the DTG curves of the CNTs of EX6, EX1 and EX5 derived from the TGA curves of the same.

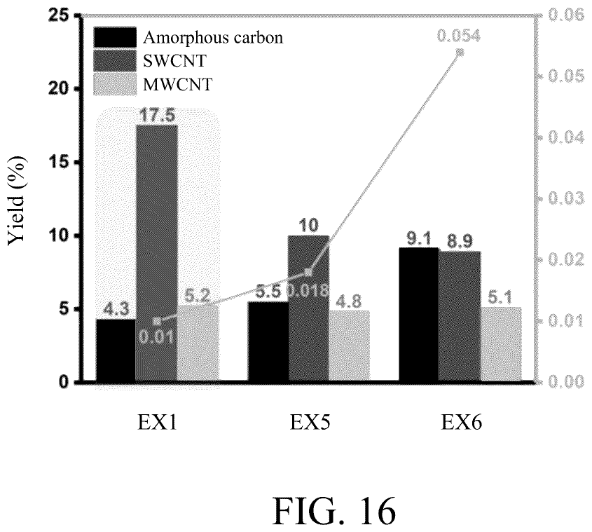

FIG. 16 is a graph showing the yields of SWCNTs, MWCNTs and amorphous carbon determined from the CNTs of a respective one of EX1, EX5 and EX6. As shown in FIG. 16, the yield of SWCNTs in EX5 was higher compared with that of EX6, while the yield of SWCNTs in EX1 was even higher compared with that of EX5. In addition, the yield of amorphous carbon of EX1 was lower compared with those of EX5 and EX6. These result indicates that the decrease in the weight ratio of CVB 720 to plastic material, i.e., from 2.5:1 to 0.25:1, is positively correlated to the increase in the yield of SWCNTs.

### 7. Effect of Retention Time Period of Hydrocarbon Compounds on the Yield of SWCNTs

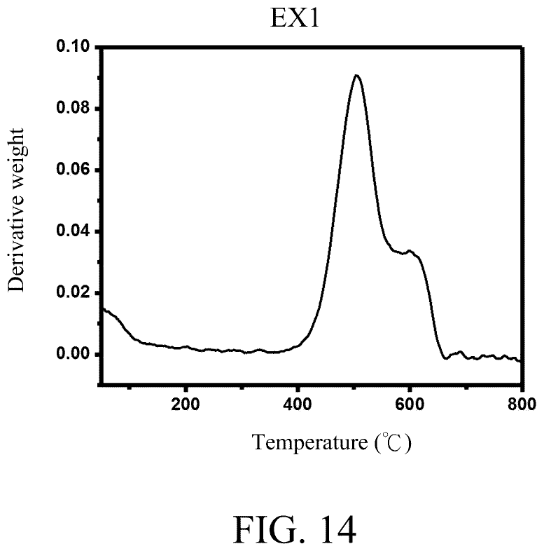

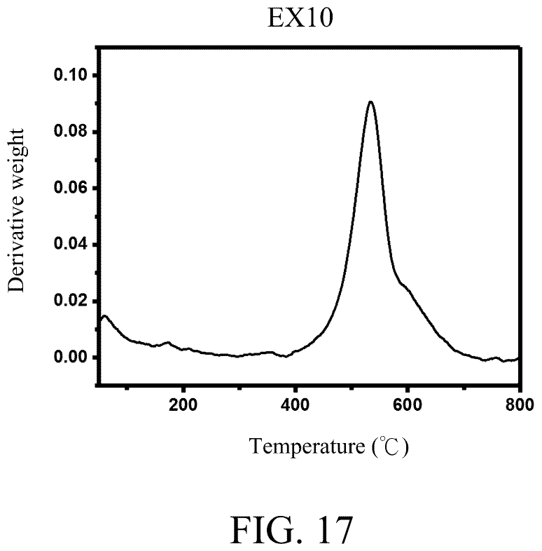

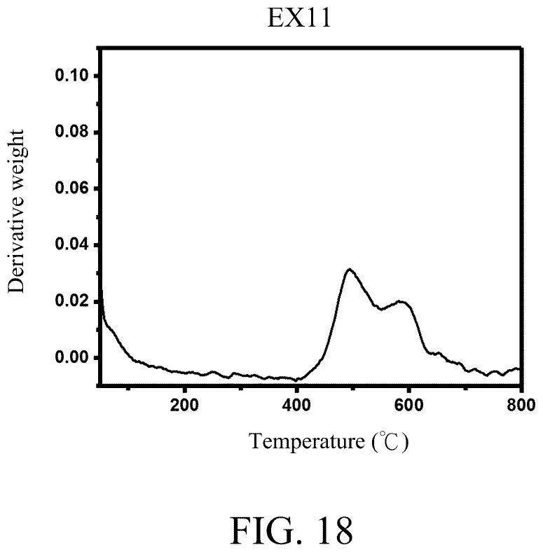

The hydrocarbon compounds generated after the pyrolysis reaction in the preparation of the CNTs of a respective one of EX1, EX10 and EX11 were subjected to the GC-MS analysis as described in Item 4 above, so as to determine the composition of the same, followed by subjecting the CNTs obtained after the catalysis reaction to TGA so as to determine the yields of SWCNTs, MWCNTs and amorphous carbon using the Equation (II) as described in Item 3 above. The results are shown in FIGS. 14 and 17 to 20.

FIGS. 14, 17 and 18 respectively show the DTG curves of the CNTs of EX1, EX10 and EX11 derived from the TGA curves of the same.

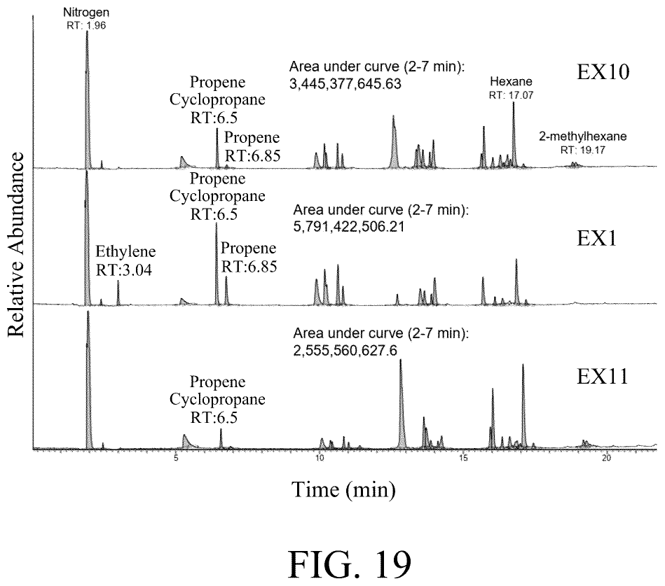

FIG. 19 are chromatograms showing the composition and relative abundance of the hydrocarbon compounds generated in the preparation of the CNTs of a respective one of EX1, EX10 and EX11 at different retention times of the GC-MS analysis. As shown in FIG. 19, the relative abundance of hydrocarbon compounds having 2 and 3 carbon atoms, e.g., ethylene, propene, propane, and cyclopropane was greater in EX1 compared with that in a respective one of EX10 and EX11, indicating that there was a relatively higher proportion of hydrocarbon compounds having 2 and 3 carbon atoms among the hydrocarbon compounds generated after the pyrolysis reaction and having a retention time of 2.54 seconds in the first reactor (i.e., occurred when the hydrocarbon compounds were carried by the nitrogen gas from the first reactor into the second reactor under a flow rate of 100 mL per minute).

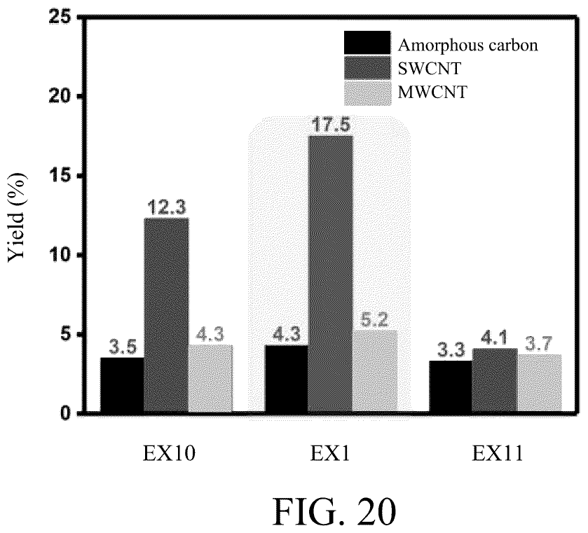

FIG. 20 is a graph showing the yields of SWCNTs, MWCNTs and amorphous carbon determined from the CNTs of a respective one of EX1, EX10 and EX11. As shown in FIG. 20, the yield of SWCNTs in EX1 was higher compared with that in a respective one EX10 and EX11, indicating that the greater amount of hydrocarbon compounds having 2 and 3 carbon atoms produced likely contributes to the increase in the yield of SWCNTs.

### 8. Effect of Fe Amount of the Catalyst on the Size of CNT and Yield of SWCNTs

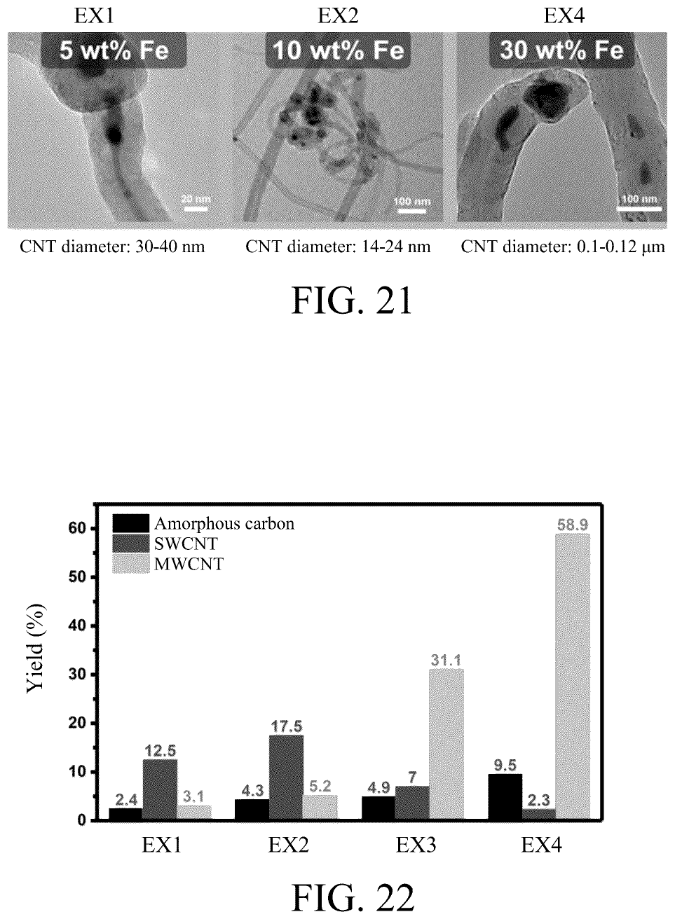

In order to determine the amount of Fe of the catalyst which would contribute to a relatively high yield of SWCNTs, the CNTs of a respective one of EX1 to EX4 were subjected to TEM as described in Item 1 above and then to TGA as described in Item 3 above, followed by determination of the yields of SWCNTs, MWCNTs and amorphous carbon using the Equation (II) as described in Item 3 above. The results are shown in FIGS. 21 and 22.

FIG. 21 are TEM images showing the CNTs of a respective one of EX1, EX2 and EX4. As shown in FIG. 21, the CNTs of EX1, EX2 and EX4 had diameters ranging from 30 nm to 40 nm, 14 nm to 24 nm and 0.1 μm to 0.12 μm, respectively. These result suggests that aggregation of Fe might occur when the amount of Fe was greater than 10 wt % based on 100 wt % of the catalyst, resulting in the CNTs having a relatively large diameter, whereas rapid precipitation of carbon might occurred due to the high carbon feeding rate when the amount of Fe was less than 10 wt % based on 100 wt % of the catalyst, also resulting in the CNTs having a relatively large diameter.

FIG. 22 is a graph showing the yields of SWCNTs, MWCNTs and amorphous carbon determined from the CNTs of a respective one of EX1 to EX4. As shown in FIG. 22, the yield of SWCNTs in a respective one of EX1 and EX2 was higher compared with that in a respective one of EX3 and EX4, indicating that when Fe present in an amount ranging from 5 wt % to 10 wt % based on 100 wt % of the catalyst, Fe nanoparticles were generated in a relatively high amount without aggregation of Fe, resulting the yield of SWCNTs being higher compared with that of MWCNTs, and that when Fe present in an amount ranging from 20 wt % to 30 wt % based on 100 wt % of the catalyst, aggregation of Fe occurred, causing a reduction in the yield of SWCNTs and a corresponding increase in the yield of MWCNTs. In addition, the yield of SWCNTs in EX2 was higher compared with that of EX1, indicating that when the amount of Fe was optimized to 10 wt % based on 100 wt % of the catalyst, aggregation of Fe and rapid precipitation of carbon can be avoided, resulting in a relatively high yield of SWCNTs and a relatively low yield of MWCNTs.

### 9. Effect of Different Types of Polymers of Plastic Material on the Yield of CNTs

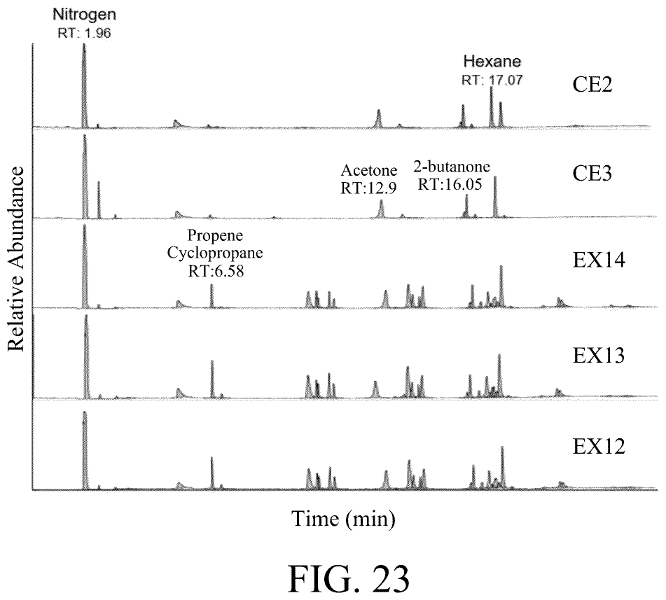

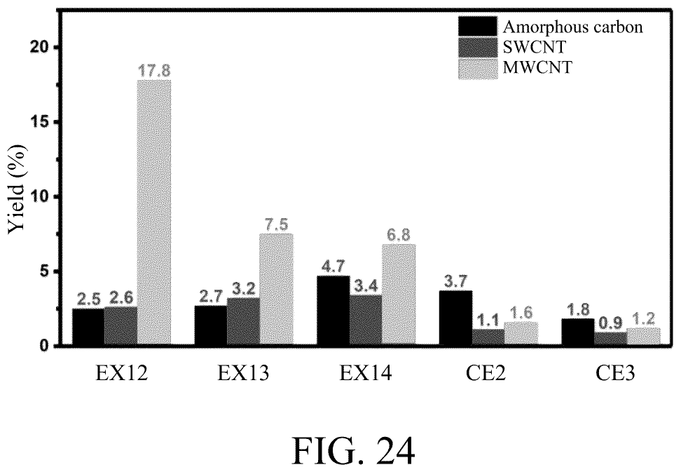

The hydrocarbon compounds generated after the pyrolysis reaction of different types of polymers of plastic materials in the preparation of the CNTs of a respective one of EX12 to EX14, CE2 and CE3 were subjected to the GC-MS analysis as described in Item 4 above, so as to determine the composition of the same, followed by subjecting the CNTs obtained after the catalysis reaction to TGA so as to determine the yields of SWCNTs, MWCNTs and amorphous carbon using the Equation (II) as described in Item 3 above. The results are shown in FIGS. 23 and 24.

FIG. 23 are chromatograms showing the composition and relative abundance of the hydrocarbon compounds generated in the preparation of the CNTs of a respective one of EX12 to EX14, CE2 and CE3 at different retention times of the GC-MS analysis. As shown in FIG. 23, the relative abundance of alkanes (i.e., cyclopropane, hexane), alkenes (i.e., propene), and acetone 2-butanone was greater in a respective one of EX12 to EX14 compared with that in a respective one of CE2 and CE3, while aromatic hydrocarbon compounds were likely to be the dominant product obtained after the pyrolysis reaction in a respective one of CE2 and CE3 (result not shown).

FIG. 24 is a graph showing the yields of SWCNTs, MWCNTs and amorphous carbon determined from the CNTs of a respective one of EX12 to EX14, CE2 and CE3. As shown in FIG. 24, the yields of SWCNTs in a respective one of EX12 to EX14 was approximately 3%, while the yield of SWCNTs in a respective one of CE2 and CE3 was merely approximately 1%. In addition, the yield of MWCNTs in a respective one of EX12 to EX14 was higher compared with that in a respective one of CE2 and CE3. These results indicate that alkanes and/or alkenes, which are main products obtained after pyrolysis of polyolefins (i.e., LDPE, HDPE and PP), facilitates the formation of CNTs (i.e., SWCNTs and MWCNTs).

In summary, by inclusion of an acidic zeolite (i.e., a zeolite having a relatively low molar ratio of SiO₂ to Al₂O₃) in a pyrolysis reaction of a plastic material, hydrocarbon compounds having 1 to 6 carbon atoms can be produced in a relatively high amount after the pyrolysis reaction, and such hydrocarbon compounds, when subjected to a catalysis reaction in the presence of a catalyst that includes ferromagnetic nanoparticles having an average diameter ranging from 20 nm to 30 nm and being derived from acetylacetonate of a ferromagnetic transition metal, facilitates the formation of SWCNTs, i.e., enhances the yield of SWCNTs.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for producing carbon nanotubes, comprising:
subjecting a plastic material and an acidic zeolite to a pyrolysis reaction so as to form a hydrocarbon compound having 1 to 6 carbon atoms, the acidic zeolite having a molar ratio of SiO₂ to Al₂O₃ ranging from 5.1:1 to 80:1.

2. The method as claimed in claim 1, further comprising:
subjecting the hydrocarbon compound and a catalyst to a catalysis reaction so as to obtain the carbon nanotubes, the catalyst including a support and a plurality of ferromagnetic nanoparticles supported on the support, the ferromagnetic nanoparticles having an average diameter ranging from 20 nm to 30 nm.

3. The method as claimed in claim 1, wherein the plastic material includes a polyolefin.

4. The method as claimed in claim 3, wherein the polyolefin includes polyethylene, polypropylene, polybutylene, polypentylene, or combinations thereof.

5. The method as claimed in claim 1, wherein the hydrocarbon compound includes ethylene, propene, propane, cyclopropane, methylcyclopropane, 2-methyl-2-butene, hexane, or combinations thereof.

6. The method as claimed in claim 1, wherein a weight ratio of the acidic zeolite to the plastic material ranges from 0.25:1 to 2.5:1.

7. The method as claimed in claim 1, wherein the pyrolysis reaction is conducted at a temperature ranging from 450° C. to 600° C.

8. The method as claimed in claim 1, wherein the pyrolysis reaction is conducted under an inert atmosphere.

9. The method as claimed in claim 2, wherein the catalysis reaction is conducted at a temperature ranging from 700° C. to 1000° C.

10. The method as claimed in claim 2, wherein the catalysis reaction is conducted under an inert atmosphere.

11. The method as claimed in claim 2, wherein the ferromagnetic nanoparticles are present in an amount ranging from 5 wt % to 30 wt % based on 100 wt % of the catalyst.

12. The method as claimed in claim 2, wherein a weight ratio of the catalyst to the plastic material ranges from 0.3:1 to 2:1.

13. The method as claimed in claim 2, wherein
the ferromagnetic nanoparticles includes a ferromagnetic transition metal which includes iron, cobalt, nickel, or combinations thereof; and
the support includes a support material which includes silica, alumina, or a combination thereof.

14. The method as claimed in claim 13, wherein the catalyst is synthesized by subjecting a mixture containing the support material and acetylacetonate of the ferromagnetic transition metal to a pyrolysis process to form a reaction intermediate which includes the support, the ferromagnetic nanoparticles supported on the support, and a carbon layer coated on the ferromagnetic nanoparticles; and subjecting the reaction intermediate to a calcination process to remove the carbon layer, and a reduction process so as to obtain the catalyst.

15. The method as claimed in claim 14, wherein the pyrolysis process is conducted at a temperature ranging from 450° C. to 500° C.

16. The method as claimed in claim 14, wherein the calcination process is conducted at a temperature ranging from 750° C. to 900° C.

17. The method as claimed in claim 14, wherein the reduction process is conducted at a temperature ranging from 600° C. to 800° C.

18. The method as claimed in claim 2, wherein the pyrolysis reaction is conducted in a first reactor, and the catalysis reaction is conducted in a second reactor disposed downstream of the first reactor, a retention time period of the hydrocarbon compound in the first reactor ranging from 1.27 seconds to 5.08 seconds.

19. A method for producing carbon nanotubes, comprising:
subjecting a hydrocarbon compound having 1 to 6 carbon atoms and a catalyst to a catalysis reaction so as to obtain the carbon nanotubes, the catalyst including a support and a plurality of ferromagnetic nanoparticles supported on the support, the ferromagnetic nanoparticles having an average diameter ranging from 20 nm to 30 nm, and being derived from acetylacetonate of a ferromagnetic transition metal.

20. The method as claimed in claim 19, wherein the ferromagnetic transition metal includes iron, cobalt, nickel, or combinations thereof.
